(19) United States
(12) Patent Application Publication
(10) Pub. No.: US 2011/0179666 A1
(43) Pub. Date: Jul. 28, 2011

(54) Burner for dryers and process of manufacturing said burner

(75) Inventor: Giorgio Offredi, Galbiate (LC) (IT)

(73) Assignee: CASTFUTURA S.p.A., Milano (IT)

(21) Appl. No.: 12/695,060

(22) Filed: Jan. 27, 2010

(51) Int. Cl. F26B 25/06; F23D 14/46; F23D 14/62; F23D 14/12; B21D 53/00; F16M 13/02; F16M 13/00

(52) U.S. Cl. 34/201; 431/202; 431/354; 431/326; 29/890.02; 248/205.1; 248/274.1

(57) ABSTRACT

A burner for dryers that includes a tubular element having at least a funnel-shaped region tapering toward an inlet end for fuel gas and combustion air to form a gas/air mixing venturi tube, and an opposite having an outlet nozzle for said mixture. According to the invention, the burner body is made of two half shells tightly joined together along corresponding mutually coupling longitudinal flanges, which, once coupled together, form two opposite perimetrical longitudinal edges The burner body has a substantially rectangular plan shape with two longitudinal edges that are parallel substantially for the entire length of the burner body. The invention relates also to a process for manufacturing said burner.

### FIELD OF THE INVENTION

The invention relates to a burner that includes a tubular element having at least a funnel-shaped region tapering toward an inlet end for the fuel gas and combustion air to form a gas/air mixing venturi tube, an opposite end having an outlet nozzle for said mixture.

### BACKGROUND OF THE INVENTION

This type of burners are known and widely used, particularly in the field of dryers. The operational principle is that of induction burners, wherein combustion air under atmospheric pressure is drawn within the burner by the provision of a venturi tube that is a section tapering in the flow direction of the supplying gas, thus leading to an increase in the velocity thereof and also leading to a consequent drop in pressure, which causes air to be drawn in. The amount of drawn air is a function of the section of the air inlet nozzle, which is generally made variable by means of a sleeve that can be locked between a position, in which the nozzle is completely open and another position, in which it is completely closed, or by means of suitably shaped injectors.

In order to direct the flame, there is provided a parabola/reflector which is fastened to the tubular body by welding spots near the outlet nozzle, while a mounting, welded to the burner body generally in a median position, allows the burner to be fastened to a wall of a user apparatus, particularly to a dryer.

Such burners are generally made of steel with the tapering section forming the venturi tube made by a drawing process. As ends, particularly the gas/air mixture outlet end, are truncated, burners of different lengths may be provided by cutting a single type of tube or a reduced number of tube types, with no need to have in stock a plurality of parts with predetermined lengths, designed for the different uses.

However, this advantage, typical for tube burners, has a drawback in that some parts, such as the parabola/reflector and the fastening mounting, need to be welded to the tubular body after cutting it. Said parts can be properly positioned only after having defined the longitudinal dimension of the tubular body. For example, the fastening mounting is generally welded in a median position with respect to all the length of the tubular body in order to be fastened to the walls of the user apparatus more efficiently, while the parabola/reflector is welded in a region near the mixture outlet end such to properly direct the flame.

Moreover, the steel tubes are not made by extrusion but by bending a metal sheet, and so they have a longitudinal welding line. The longitudinal welding may open during the drawing process aimed at tapering the end in which the venturi tube is provided, or said opening may occur later during use by the user due to thermal shocks, with a serious damage to the manufacturer's reputation.

### SUMMARY OF THE INVENTION

The present invention aims at providing a burner, particularly for dryers, having improvements intended to rationalize and speed up its manufacture, reducing and facilitating the assembling operations, above all reducing the use of parts to be rigidly fastened in position, particularly by a welding process.

The invention achieves that aim by providing a burner such as described hereinbefore, wherein the burner body is made of two half shells tightly joined together along corresponding mutual coupling longitudinal flanges, which flanges, once coupled together, form two opposite perimetrical longitudinal edges, the burner body having a rectangular plan shape that is a substantial rectangular shape in a section plane parallel to the longitudinal plane and to said longitudinal flanges, particularly in the plane separating the two half shells wherein the two longitudinal edges are parallel substantially for the whole length of the burner body.

The invention is based on the concept of making the burner body by coupling two parts which is typical of the so called flat burners for oven or grill by advantageously particularly acting on the shape of said parts and on the mutual contact surface thereof.

The invention provides the burner body to be made of two half shells such to have, in the assembled condition, at least a longitudinal edge advantageously composed of the coupling surfaces of corresponding longitudinal flanges provided on said half shells. This allows the greatest modularity and size adaptability to be guaranteed by using simple operations for molding metal sheets without using welding operations. It is possible to removably and adjustably place the several parts of the burner, particularly the parabola/reflector and the fastening mounting on the burner body, possibly also during the assembling step, advantageously using the same coupling surfaces of the half shells as longitudinal guides to which slides or runners associated to said parts can be correspondingly coupled. Among other things, the invention provides a clear positive impact on total costs.

The longitudinal flanges of the half shells are typically crimped or riveted or the like in order to guarantee the tight effect. For example it is possible to provide at least a flange to have a greater extension such that it can act as a tab to be bent and riveted on the other flange of the pair.

The half shells forming the burner body are typically divided, but, in a particularly advantageous embodiment they are made as one piece. In this case two corresponding longitudinal flanges of the half shells are joined together along a bending line extending along at least one of the two longitudinal edges of the burner body. Therefore the burner body is made by bending the pair of joined flanges on themselves, in a substantially median region, by crimping the opposite longitudinal flanges which abut each other due to the bending process.

Flanges, coupled in this manner, both divided and continuous, are such to constitute a guide, preferably two guides for longitudinally slidably engaging one or more slides for removably fastening parts of the burner. The burner is composed of further elements, which are object of the present invention too, such as the parabola/reflector, the fastening mounting, the mounting holding the igniter and/or the thermocouple and the like, which require to be fastened in position on the burner body. By the provision of the longitudinal guides, it is sufficient to provide such elements with slide or runner-like fastening means that can be slidably engaged on such longitudinal guide or guides in order to make an efficient removable coupling.

Advantageously one or more parts or elements of the burner have a pair of opposite slides for being slidably engaged on both the longitudinal guides of the burner such that the fastening process is made still more stable.

The slide or slides typically comprise one or more U shaped bent elements intended for being engaged in the corresponding burner guide. In order to fasten said slide or said slides in position it is also possible to provide the use of releasable engagement means. The latter can be the U shaped elements which are pressed on the guide once the desired fastening position is reached, but they can be also suitable elements, such as screws or bolts engaging the burner body or can be elastic clips upon which it is necessary to act for moving the guides.

As mentioned above, one of the typical elements of the burner is the parabolic reflector. This can be coupled to a single guide, but typically it has coupling means with a pair of opposite slides for being slidably engaged on both the longitudinal guides of the burner for removably fastening said reflector to the burner for example by means of ends provided with U shaped bent elements. The reflector and said U shaped elements can be advantageously made as one piece by processing a metal sheet with clear advantages as regards the construction.

A further generally used element is a mounting for fastening the burner to a user apparatus such as a dryer. The mounting can be engaged only with one of the two guides, but advantageously it has coupling means with a pair of opposite slides for being slidably engaged on both the burner longitudinal guides for example by means of ends provided with U shaped bent elements. The fastening mounting and said U shaped elements can be made as one piece too by processing a metal sheet, for example the same metal sheet from which the parabolic reflector and/or one or both the half shells constituting the burner body are obtained.

The fastening mounting can have a slide for being slidably coupled to a guide of the burner, while the other guide is engaged with slides which are held, or formed, on corresponding longitudinally spaced supporting arms. This guarantees the mounting to be strongly fastened to the burner body.

According to an embodiment, the venturi tube has at least an aperture for the intake of the primary combustion air, for example on a supplying gas inlet mouth, and it further comprises a tubular sleeve that can slide in the direction of the axis of the venturi tube between a position in which the intake aperture is substantially completely closed and a position in which it is substantially completely open, to adjust the stoichiometric gas/air ratio. The sleeve is typically associated to at least a slide for being slidably engaged with at least a longitudinal guide of the burner and releasable locking means for being fastened in position, such as for example a screw.

According to a preferred embodiment, the burner comprises a pair of intake apertures which are symmetrically arranged on the first and second half shell while the sleeve advantageously has a pair of complementary semicircular section surfaces longitudinally sliding on the burner body. These surfaces are typically made as one piece by cutting and bending a metal sheet contemporaneously forming a U shaped section web intended to be engaged with a burner guide. Obviously it is possible to provide two webs in order to be engaged with both the guides.

Advantageously the inlet mouth is connected to the burner body by means of the venturi tube, which venturi tube is composed of a tubular element having the shape of a double opposing truncated cone. Particularly the venturi tube comprises a tubular portion which tapers toward the gas/air mixture supplying end, a constant section portion and then a portion which widens to be connected to the inlet mouth.

According to a variant, one or more injectors can be provided for injecting air and/or gas and/or gas/air mixture inside the burner. Said injectors are preferably shaped such to be coupled with one or more apertures of the burner body, particularly with the intake aperture, either directly or through one or more apertures obtained in the tubular sleeve, and/or with the inlet end and/or with apertures suitably obtained on the burner body.

Likewise other members, injectors can also advantageously have slide fastening means for slidably engaging at least a longitudinal guide of the burner.

Both the half shells constituting the burner body and its several components such as the fastening mounting, the parabola/reflector, the sleeve adjusting the air flow, the arm holding the igniter and/or the thermocouple can be advantageously made by molding and cutting metal sheets, particularly by molding and cutting a single metal sheet.

The invention relates also to a kit of mountings for fastening the burner to user apparatuses. Each mounting of the kit has locking means which are different for different types and size of user apparatuses and it comprises at least a slide element, typically two opposite slide elements, for being slidably coupled to corresponding guides of the burner according to the invention.

According to another aspect the invention relates to a process for manufacturing a burner with an integrated Venturi tube, wherein it comprises the following steps:

making an upper half shell with an integrated half shell at one of its ends to form a part of a venturi tube and a complementary lower half shell with an integrated half shell at one of its ends to form the other part of the venturi tube by cutting a metal sheet, bending, drawing and trimming its edges, said half shells having corresponding abutment longitudinal flanges;

coupling the two half shells by aligning the corresponding abutment longitudinal flanges to form the burner body by contemporaneously forming the venturi tube;

crimping or riveting said longitudinal flanges for guaranteeing the tight effect by contemporaneously forming at least a longitudinal guide for fastening one or more slides or runners associated to one or more elements of the burner such as a fastening mounting or a parabola/reflector to make a sliding connection along said at least one guide for adjustably positioning said element or said elements on the burner.

According to a variant the process can provide the following steps:

making an upper half shell with an integrated half shell at one of its ends to form a part of a venturi tube and a complementary lower half shell with an integrated half shell at one of its ends to form the other part of the venturi tube by molding and cutting a metal sheet, said half shells having a first and a second pair of corresponding abutment longitudinal flanges, the first pair of flanges being joined along a bending line in a substantially median region;

bending the two half shells along said bending line by aligning the second pair of longitudinal flanges to form the burner body by contemporaneously forming the venturi tube and a first edge of the burner body;

making a second edge of the burner body by crimping and/or riveting the second pair of longitudinal flanges to guarantee the tight effect;

the two longitudinal edges forming a pair of longitudinal guides for fastening one or more slides or runners associated to one or more elements of the burner such as a fastening mounting or a parabola/reflector to make a sliding connection along said guides for adjustably positioning said element or said elements on the burner.

Advantageously there can be provided also the additional following steps:

making a parabola/reflector with one end provided with U shaped bent elements for being slidably coupled to the corresponding burner guides by molding a metal sheet;

previously locking the parabola/reflector to the burner guides;

sliding in the direction of the longitudinal axis of the burner body;

locking in position by releasable fastening means.

The additional following steps can also be provided:

making a mounting for locking the burner to a user apparatus such as a dryer, which mounting has ends provided with U shaped bent elements for being slidably coupled to the corresponding burner guides, said fastening mounting and said U shaped elements being made as one piece by processing a metal sheet;

previously locking the mounting to the burner guides;

sliding in the direction of the longitudinal axis of the burner body;

locking in position by releasable fastening means.

The following optional step can also be provided:

making a first slide for slidably coupling the mounting to a burner guide, the other guide being engaged with slides held, or formed on, a pair of longitudinally spaced supporting arms which are integrated with said first slide.

In order to make a simple but effective system allowing the gas/air stoichiometric ratio to be adjusted, it is possible to provide the following further steps:

making an aperture on the surface of the venturi tube for the intake of the primary combustion air;

introducing a tubular sleeve that can slide in the direction of the axis of the venturi tube between a position in which the intake aperture is substantially completely closed and a position in which it is substantially completely open, to adjust the stoichiometric gas/air ratio, said sleeve being provided with means for being fastened to a slide for the sliding engagement with a longitudinal guide of the burner;

locking in position said slide by releasable fastening means.

Additional features and improvements are the object of the dependent claims.

### BRIEF DESCRIPTION OF THE DRAWINGS

Characteristics of the invention and advantages deriving therefrom will be clearer from the following detailed description of annexed drawings, wherein:

FIGS. 1-3 are different perspective views of an embodiment of the burner according to the present invention; and

FIG. 4 is a perspective and partial cross-section view of the burner according to the previous figures.

### DETAILED DESCRIPTION OF THE INVENTION

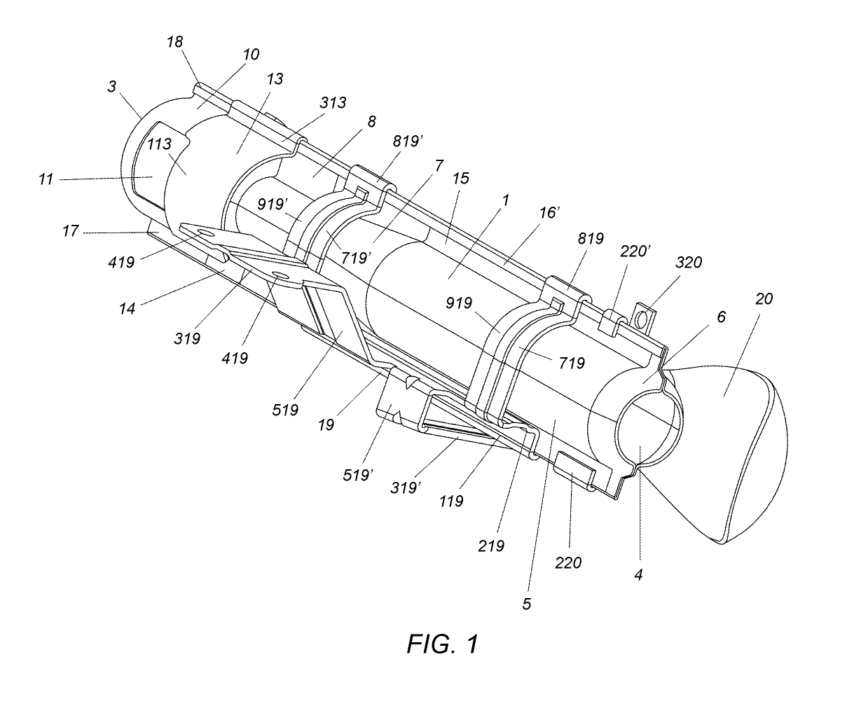

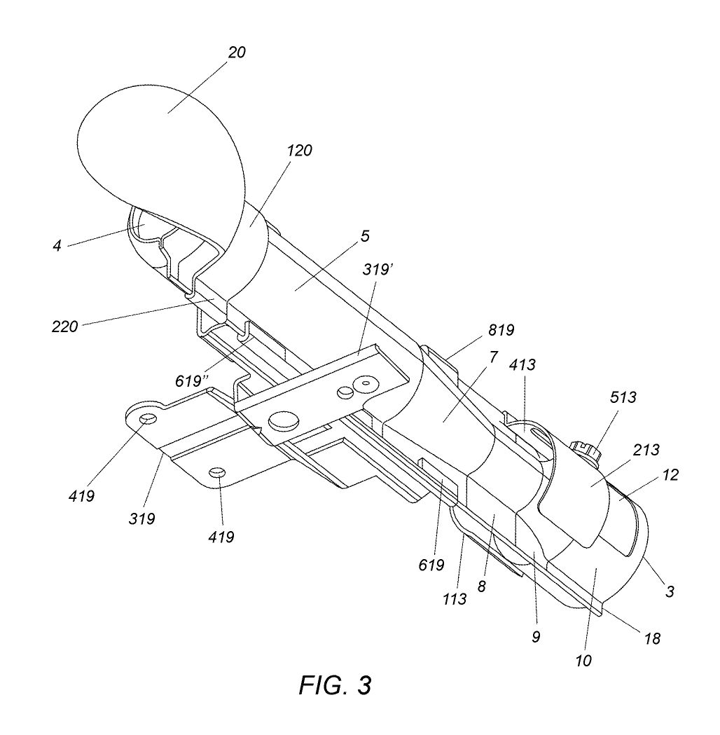

With reference to FIGS. 1 to 4, an embodiment of the burner according to the present invention comprises a pair of half shells 1, 2 that forms, in the coupled condition, a tubular body having a proximal inlet end 3 for the gas/air mixture and a distal outlet end 4 for said mixture. By way of example the tubular body can be divided into five regions with reference to its cross-section. Starting from the gas/air mixture outlet end 4, there is provided a short junction portion 6 which widens toward a uniform section region 5, then a region 7 where the section tapers toward the inlet end to take a uniform value in the portion denoted by reference number 8. Then the section widens in portion 9 to return again to a uniform section in the final portion 10 near the inlet end 3. The uniform section portion 10 has a pair of opposite circumferential apertures 11 and 12 on the first half shell 1 and on the second half shell 2 respectively in a substantially median position of the portion 10. Such apertures 11, 12 act for the intake of the primary air for driving the burner, while supplying gas is fed by a mouth (not shown in the figures) directly connected to the end 3.

The operation principle is that of burners with venturi tube wherein the combustion air under atmospheric pressure is drawn into the burner by means of the portion 9, so called converging portion that, due to its constriction, causes the velocity of the supplying gas to increase and consequently causes the pressure to be reduced thus drawing air into the burner. In the portion 7, so called diverging diffuser, the turbulence decreases and energy is recovered which is converted into static pressure intended to overcome the output counterpressure. As the amount of air drawn in is a function of the section of the intake apertures 11 and 12, the use of the sleeve 13 is provided which can be locked between a position in which the apertures 11 and 12 are substantially completely open and a position in which they are substantially completely closed. The particular arrangement of the sleeve 13 will be described below in more details.

The half shells 1, 2 are typically obtained by metal sheet molding such to form complementary parts of the tubular body in a simple and inexpensive way.

Advantageously the half shells are made such to have corresponding pairs of longitudinal flanges 14, 14′ and 15, 15′ in order to facilitate the tight coupling. Such flanges typically extend for all the longitudinal extension of the half shells such as in the embodiment shown in the figures even if said flanges can take only a portion of the longitudinal extension. Such flanges 14, 14′, 15, 15′ in addition to facilitate the coupling, allow a pair of parallel longitudinal edges 17, 18 to be made substantially for all the length of the burner body. Such edges 17, 18 are obtained after overlapping corresponding flanges 14, 14′ and 15, 15′ and therefore their thickness is about twice the thickness of each individual flange.

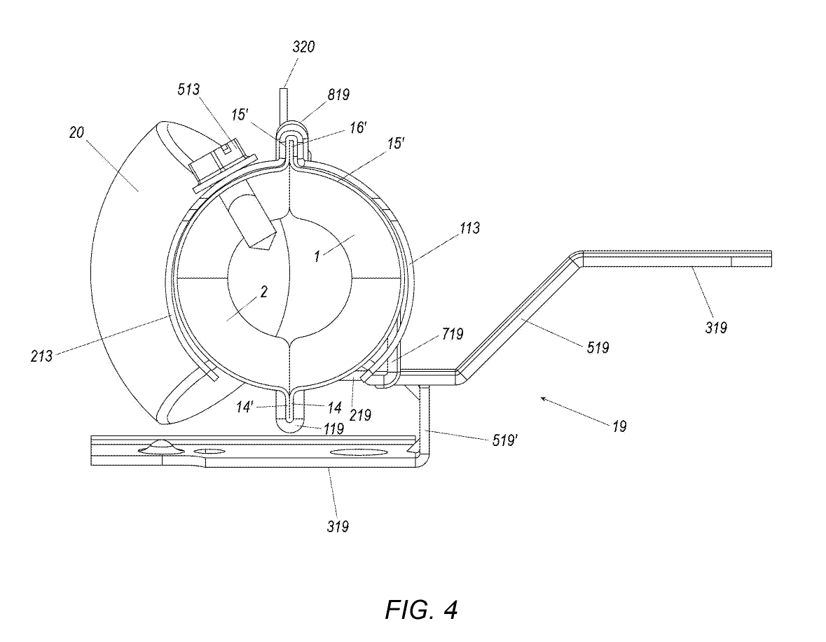

In order to guarantee the tight effect it is possible to provide corresponding flanges not to have the same transverse extension, but one of them can have a greater extension, for example a double one, like a tab to be bent and riveted on the other flange after the abutment process. In the shown embodiment, the guide denoted by the reference number 18 is composed of flanges 15 and 15′ belonging to the half shell 1 and 2 respectively with the extension 16′ of the flange 15′ bent on the flange 15 such as shown both in FIGS. 1 and 4. However the tight effect can be obtained by using other fastening methods such as by crimping flanges by interposing or not one or more U shaped section junction elements (not shown in the figures).

As an alternative or in combination it is possible to provide the half shells to be made as one piece such to be joined along a longitudinal perimetrical edge. In this particularly advantageous embodiment, the tight effect along one of the two edges is automatically guaranteed said edge being obtained by bending the half shells one on each other along a bending line arranged in a substantially median position. There is no need for a crimping process for making such edge since flanges are already joined together thus clearly making the manufacturing process more easy and decreasing costs. In this case it has to be noted that both the half shells can be made contemporaneously by processing the same metal sheet. Moreover the operation for coupling the half shells is facilitated since the bending line is provided already during the molding step such that the two portions can perfectly match, avoiding tight problems due to possible misalignments often arising when coupling separate parts having no matching elements. In the shown embodiment, the guide denoted by the reference number 17 is composed of flanges 14 and 14′ made as one piece and bent on themselves such as shown in details in FIG. 4.

The shells can be tightly coupled in any manner provided that it allows one, preferably two longitudinal guides along substantially the entire length of the burner body to be made in order to allow it to be slidably coupled to other members of the burner. That allows the step welding such elements on the burner body to be avoided with a clear reduction of costs, but it allows also the type of element to be selected and its position to be adjusted depending on the characteristics of the user apparatus. Suffice it to say the mounting for fastening the burner to the user apparatus. The latter, can be adjustably placed in order to be adapted to the size of the burner, and it can also be selected from a kit of mountings having different fastening elements depending on the type and on the size of the user apparatus, for example a dryer. All that can be also carried out during the assembling step without providing several molding lines for the half shells composing the burner body.

In the example shown in the figures, the fastening mounting 19 is composed of a U shaped element 119 intended to be fitted in the guide 17 like a slide or runner. Specifically, the portion of the U shaped element 119 abutting with the flange 14 is continuous and bent on one end to form a supporting square 219 for two coupling plates 319, 319′ provided with holes 419. The plates are supported by a pair of arms 519, 519′ branching in opposite directions with respect to the slide 17 such that plates 319, 319′ are placed, in the assembled condition, on the opposite sides of the burner for example to guarantee them to be firmly fastened to the top wall of a dryer. At the opposite side, the surface of the U shaped element 119 abutting with the flange 14′ is not continuous, but it is divided into several parts, specifically three parts, like tabs 619′, 619″, 619″. This makes it easier to introduce and slide the element 119 into the guide 17. Obviously there is nothing to prevent said abutment surface from being made in a continuous manner. Tabs 619′, 619″, 619″ can be also used for locking the mounting in position by bending one or more of said tabs on the guide 18.

In order to guarantee an effective fastening, the mounting advantageously has two arms 719, 719′ having a U shaped bent end 819 819′ intended to be engaged in the burner guide 18, the opposite end being integral with the supporting square 219 of the fastening plates 319, 319′. The two arms are arranged at a certain distance substantially equal to the longitudinal size of the mounting and are shaped such to slide on the surface of the burner body, particularly on the portion 5 thereof having the greatest section. The two arms 719, 719′ in the center have a clip 919, 919′ obtained on the surface thereof acting in the direction contacting the guide 18 in order to guarantee the mounting to be removably fastened in position.

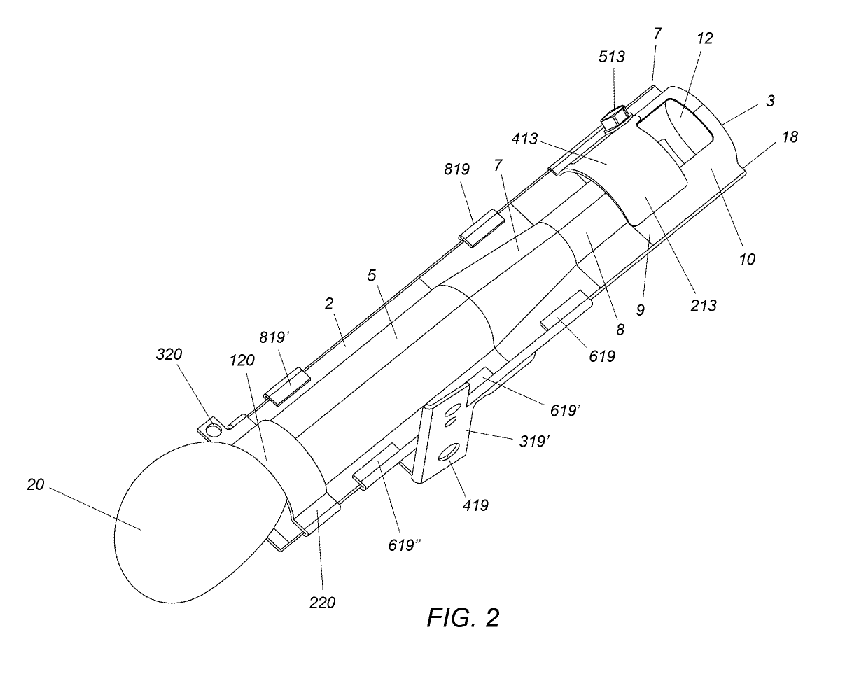

In order to properly direct the flame, the burner according to the invention provides the use of a parabola/reflector 20 having a typically spoon-like configuration to be placed near the gas/air mixture outlet end 4. Advantageously such parabola 20 has a coupling annular band shaped end 120 with a diameter slightly greater than the diameter of the section of the greatest section tubular body 5 with a pair of U shaped bent elements 220, 220′ arranged on opposite sides such that it is slidably engaged with the guides 17, 18 of the burner like a slide or runner. FIGS. 1 and 2 further show a perforated tab 320 for possibly supporting other elements such as for example an igniter (not shown in the figures).

In order to adjust the stoichiometric gas/air ratio, the burner according to the invention provides the use of a sleeve 13 arranged in such a way to cover apertures 11, 12 described above. Such sleeve 13 can take any shape, but preferably it is composed of a pair of half rings 113, 213 bent at one end such to form a U shaped element 313 intended for being engaged with one of the two guides 18. The diameter of the half rings 113, 213 is slightly greater than the diameter of the inlet section 10 such that they can slide on the tubular surface between a position in which the apertures 11, 12 are substantially completely open and a position in which they are substantially completely closed. The position of the sleeve 13 with respect to apertures 11, 12 is defined by the position of the U shaped element 313 on the guide 18. A slot 413 is provided on one of the two half rings 213 for locking the sleeve 13 in position by means of a screw 513.

The invention is not limited to the embodiments described and illustrated herein, but may be greatly varied, especially as regards construction. For instance, it is possible to provide a different mechanism for fasting the mounting and/or the parabola for example by using only one guide of the burner, or it is possible to provide the stoichiometric gas/air ratio adjustment sleeve to be engaged on both the guides and/or to act only on one of the two apertures or it is possible to use, as an alternative or in combination, one or more injectors suitably shaped to be engaged with an aperture of the sleeve and/or directly with the intake aperture and/or with the inlet end and/or with nozzles suitably obtained on the burner body. Also in this case, in the same manner as for other members of the burner, it is possible to provide such injectors to be advantageously slidably fastened to one or both the longitudinal guides. All this variations are to be introduced without departing from the guiding principle disclosed above and claimed below.

While the invention has been described in connection with the above described embodiments, it is not intended to limit the scope of the invention to the particular forms set forth, but on the contrary, it is intended to cover such alternatives, modifications, and equivalents as may be included within the scope of the invention. Further, the scope of the present invention fully encompasses other embodiments that may become apparent to those skilled in the art and the scope of the present invention is limited only by the appended claims.

What is claimed is:

1. A burner for dryers, comprising;
a tubular element having at least a funnel-shaped region (7, 8, 9) tapering toward an inlet end (3) for the fuel gas and combustion air to form a gas/air mixing venturi tube, the opposite end (4) having an outlet nozzle for said mixture,
wherein the burner body is made of two half shells (1, 2) tightly joined together along corresponding mutual coupling longitudinal flanges (14, 14′, 15, 15′), which flanges, once coupled together, form two opposite perimetrical longitudinal edges (17, 18), the burner body having a substantially rectangular plan shape wherein the two longitudinal edges (17, 18) are parallel substantially for the whole length of the burner body.

2. The burner according to claim 1, wherein at least a longitudinal edge (18) of the burner body is composed of a pair of corresponding longitudinal flanges (15, 15′) of the half shells which are crimped or riveted or the like in order to guarantee the tight effect.

3. The burner according to claim 1 or 2, wherein a flange (15′) of at least a pair of longitudinal flanges (15, 15′) has a greater extension such that it can be bent and riveted on the other flange of the pair like a tab (16′) in order to guarantee the tight effect.

4. The burner according to one or more of the preceding claims, wherein the half shells (1, 2) are made as one piece, two corresponding longitudinal flanges (14, 14′) of the half shells being joined together along a bending line extending along at least one (17) of the two longitudinal edges (17, 18) of the burner body.

5. The burner according to claim 4, wherein an edge (17) of the burner body is made by bending the pair of joined flanges (14, 14′) on themselves, in a substantially median region, the other edge (18) being obtained by crimping the opposite longitudinal flanges (15, 15′) which abut each other due to the bending process.

6. The burner according to one or more of the preceding claims, wherein at least one of the two pairs of longitudinal coupled flanges constitute a guide (17, 18) for longitudinally slidably engaging one or more slides for removably fastening parts of the burner.

7. The burner according to claim 6, wherein it comprises one or more parts (19, 20) having slide fastening means for being slidably coupled to at least a longitudinal guide (17, 18) of the burner.

8. The burner according to claim 6 or 7, wherein it comprises one or more parts having at least a pair of opposite slides (119, 819, 220, 220′) for being slidably coupled to both the longitudinal guides (17, 18) of the burner.

9. The burner according to one or more of the preceding claims 6 to 8, wherein said slide or said slides comprise one or more U shaped bent elements intended to be engaged into the corresponding burner guide.

10. The burner according to one or more of the preceding claims 6 to 9, wherein there are provided releasable engagement means (919, 513) for fastening said slide or said slides in position.

11. The burner according to one or more of the preceding claims 6 to 10, wherein it comprises a parabolic reflector (20), said reflector having coupling means (120) with a pair of opposite slides (220, 220′) for being slidably engaged on both the longitudinal guides (17, 18) of the burner for removably fastening said reflector to the burner.

12. The burner according to claim 11, wherein said parabolic reflector (20) has ends provided with U shaped bent elements (220, 220′) for being slidably coupled to the corresponding guides (17, 18) of the burner said reflector and said U shaped elements being made as one piece by processing a metal sheet.

13. The burner according to one or more of the preceding claims, wherein it has a mounting (19) for fastening the burner to a user apparatus such as a dryer, said mounting having coupling means with a pair of opposite slides (119, 819, 819′) for being slidably engaged on both the longitudinal guides (17, 18) of the burner.

14. The burner according to claim 13, wherein said fastening mounting (19) has ends provided with U shaped bent elements (119, 819, 819′) for being slidably coupled to the corresponding burner guides, said fastening mounting and said U shaped elements being made as one piece by processing a metal sheet.

15. The burner according to claim 13 or 14, wherein said fastening mounting (19) has a slide (119) for being slidably coupled to a guide (17) of the burner, the other guide (18) being engaged with slides (819, 819′) which are held, or formed, on corresponding longitudinally spaced supporting arms (719, 719′).

16. The burner according to one or more of the preceding claims, wherein the venturi tube has at least an aperture (11, 12) for the intake of the primary combustion air and it further comprises a tubular sleeve (13) that can slide in the direction of the axis of the venturi tube between a position in which said intake aperture (11, 12) is substantially completely closed and a position in which it is substantially completely open, to adjust the stoichiometric gas/air ratio, said sleeve (13) being associated to at least a slide (313) for being slidably engaged with at least a longitudinal guide (18) of the burner and releasable locking means (513) for being fastened in position.

17. The burner according to claim 16, wherein it comprises a pair of intake apertures (11, 12) which are symmetrically arranged on the first and second half shell (1, 2), the sleeve having a pair of complementary semicircular section surfaces (113, 213) longitudinally sliding on the burner body, said surfaces (113, 213) being made as one piece by cutting and bending a metal sheet contemporaneously forming a U shaped section web (313) intended to be engaged with a burner guide (18).

18. The burner according to claim 16 or 17, wherein said intake aperture or apertures (11, 12) are provided on a supplying gas inlet mouth (10) of the burner.

19. The burner according to claim 18, wherein said mouth (10) is connected to the burner body by means of the venturi tube, which venturi tube is composed of a tubular element having the shape of a double opposing truncated cone (7, 8, 9).

20. The burner according to claim 19, wherein said venturi tube comprises a tubular portion (7) which tapers toward the gas/air mixture supplying end, a constant section portion (8) and then a portion (9) which widens to be connected to the inlet mouth (3).

21. Burner according to one or more of the preceding claims, wherein it comprises one or more injectors for injecting air and/or gas and/or gas/air mixture inside the burner.

22. The burner according to claim 21, wherein said injectors are shaped such to be coupled with one or more apertures of the burner body.

23. The burner according to claim 22, wherein said injector or injectors are coupled with the intake aperture (11, 12) either directly or through one or more apertures obtained on the tubular sleeve (13), and/or with the inlet end (3) and/or with apertures suitably obtained on the burner body.

24. The burner according to one or more of the preceding claims 21 to 23, wherein said injector or injectors have slide fastening means for slidably engaging at least a longitudinal guide (17, 18) of the burner.

25. The burner according to one or more of the preceding claims, wherein it is made by metal sheet molding and cutting.

26. A dryer comprising a burner according to one or more of the preceding claims.

27. A parabolic reflector for tube burner (20), wherein it comprises a pair of opposite slides (220, 220′) for the sliding engagement with corresponding longitudinal guides (17, 18) of the burner for removably fastening the reflector to the burner.

28. The reflector (20) according to claim 27, wherein it has ends provided with U shaped bent elements (220, 220′) for being slidably coupled to corresponding guides (17, 18) of the burner, said reflector and said U shaped elements being made as one piece by processing a metal sheet.

29. A mounting (19) for fastening a tube burner to a user apparatus such as a dryer, wherein it comprises a pair of opposite slides (119, 819, 819′) for the sliding engagement with corresponding longitudinal guides (17, 18) of the burner.

30. The mounting (19) according to claim 29, wherein it has ends provided with U shaped bent elements (119, 819, 819′) for being slidably coupled to corresponding guides of the burner, said fastening mounting and said U shaped elements being made as one piece by processing a metal sheet.

31. A kit of mountings for fastening a burner to a user apparatus wherein it comprises at least a slide element, typically two opposite slide elements, for being slidably coupled to corresponding guides of the burner, each mounting of the kit having different fastening elements for different types and sizes of user apparatuses.

32. A process for manufacturing a burner with integrated venturi tube comprising the following steps:
making an upper half shell with an integrated half shell at one of its ends to form a part of a venturi tube and a complementary lower half shell with an integrated half shell at one of its ends to form the other part of the venturi tube by cutting a metal sheet, bending, drawing and trimming its edges, said half shells having corresponding abutment longitudinal flanges;
coupling the two half shells by aligning the corresponding abutment longitudinal flanges to form the burner body by contemporaneously forming the Venturi tube; and
crimping or riveting said longitudinal flanges for guaranteeing the tight effect by contemporaneously forming at least a longitudinal guide for fastening one or more slides or runners associated to one or more elements of the burner such as a fastening mounting or a parabola/reflector to make a sliding connection along said at least one guide for adjustably positioning said element or said elements on the burner.

33. A process for manufacturing a burner with integrated venturi tube comprising the following steps:
making an upper half shell with an integrated half shell at one of its ends to form a part of a venturi tube and a complementary lower half shell with an integrated half shell at one of its ends to form the other part of the venturi tube by molding and cutting a metal sheet, said half shells having a first and a second pair of corresponding abutment longitudinal flanges, the first pair of flanges being joined along a bending line in a substantially median region;
bending the two half shells along said bending line by aligning the second pair of longitudinal flanges to form the burner body by contemporaneously forming the Venturi tube and a first edge of the burner body; and
making a second edge of the burner body by crimping and/or riveting the second pair of longitudinal flanges to guarantee the tight effect;
the two longitudinal edges forming a pair of longitudinal guides for fastening one or more slides or runners associated to one or more elements of the burner such as a fastening mounting or a parabola/reflector to make a sliding connection along said guides for adjustably positioning said element or said elements on the burner.

34. The process according to claim 32 or 33, further comprising the following steps:
making a parabola/reflector with one end provided with U shaped bent elements for being slidably coupled to the corresponding burner guides by molding a metal sheet;
previously locking the parabola/reflector to the burner guides;
sliding in the direction of the longitudinal axis of the burner body; and
locking in position by releasable fastening means.

35. The process according to one or more of the preceding claims 32 to 34, further comprising the following steps:
making a mounting for locking the burner to a user apparatus such as a dryer, which mounting has ends provided with U shaped bent elements for being slidably coupled to the corresponding burner guides, said fastening mounting and said U shaped elements being made as one piece by processing a metal sheet;
previously locking the mounting to the burner guides;
sliding in the direction of the longitudinal axis of the burner body; and
locking in position by releasable fastening means.

36. The process according to claim 35, further comprising the following steps:
making a first slide for slidably coupling the mounting to a burner guide, the other guide being engaged with slides held, or formed on, a pair of longitudinally spaced supporting arms which are integrated with said first slide.

37. The process according to one or more of the preceding claims 32 to 36, further comprising the following steps:
making an aperture on the surface of the venturi tube for the intake of the primary combustion air;
introducing a tubular sleeve that can slide in the direction of the axis of the venturi tube between a position in which said intake aperture is substantially completely closed and a position in which it is substantially completely open to adjust the stoichiometric gas/air ratio, said sleeve being provided with means for being locked on a slide for the sliding engagement on a longitudinal guide of the burner; and
locking in position said slide by releasable fastening means.
